(19) United States
(12) Patent Application Publication
(10) Pub. No.: US 2007/0198514 A1
(43) Pub. Date: Aug. 23, 2007

(54) Method for presenting result sets for probabilistic queries

(76) Inventors: Derek L. Schwenke, Marlborough, MA (US); Thomas R. Lanning, Littleton, MA (US); Kent B. Wittenburg, Lynnfield, MA (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 11/353,289

(22) Filed: Feb. 10, 2006

(51) Int. Cl. G06F 7/00

(52) U.S. Cl. 707/7

(57) ABSTRACT

A method presents a rank-ordered result set for a probabilistic input query. Terms in the query are recognized and a probability is assigned to each term. The probability expresses a confidence in correctly recognizing the term. A database is searched for items corresponding to the probabilistic query using the terms and the assigned probabilities to produce a result set. The result set is then highlighted according to the probabilities and presented to a user.

### FIELD OF THE INVENTION

The invention relates generally to searching databases and presenting result sets, and more particularly to searching and presenting rank ordered result sets with imprecise or probabilistic queries.

### BACKGROUND OF THE INVENTION

The amount of searchable content that is produced and distributed world-wide is increasing at an enormous rate on a day to day basis. Content can be in the form of web pages, images, videos, music, and the like. Content is readily available from a number of sources, including broadcasters, cable and satellite distributors, wireless providers, and the Internet. As the amount of content increases, the problem of searching for desired content is increasing likewise.

Internet distribution channels can stream or download content directly to television systems, digital video recorders (DVRs), personal computers (PCs), and mobile devices such as cellular telephones, laptops and personal digital assistants (PDAs). PC-based browsers provide a reasonable interface for searching for content via text entry using keyboards. However, there is no satisfactory solution for searching for content using devices that do not include an alpha-numeric keyboard.

For example, a typical remote control used with televisions and other playback devices only includes a numeric keypad, cursor positioning keys, and other keys that control the various operating modes of the system that is being controlled. Most remote controls lack both pointer (mouse-like) functions, and alphanumeric keys. Option selection is done only by cursor controlled menus; text entry is extremely difficult, awkward, and time consuming. Searching for a program, when several weeks of advance programming are available for over a hundred channels on an electronic program guide (EPG), can be frustrating. In essence, a typical remote control device is useless as a text input device. The same problem exists for most small, hand-held mobile devices.

One solution is to provide a speech interface for a query interface. One interface uses speech to specify a limited set of commands, see A. Ibrahim, J. Lundberg and J. Johansson, “Speech Enhanced Remote Control for Media Terminal,” Proceedings of Eurospeech'01, Volume 4, pp. 2685-2688, 2001; and Promptu, available from AgileTV Menlo Park, Calif., USA. The Promptu remote control includes a talk button and a microphone. The remote control interfaces with a set top box to scan and find on-demand video content using predetermined speech input commands. The other interface is dialog-based, see P. Johansson, “MADFILM—A Multimodal Approach to Handle Search and Organization in a Movie Recommendation System,” Proceedings of the 1st Nordic Symposium on Multimodal Communication, pp. 53-65, Sep. 25-26, 2003; and W. Wahlster, “SmartKom: Symmetric Multimodality in an Adaptive and Reusable Dialogue Shell,” Proceedings of the Human Computer Interaction Status Conference 2003, pp. 47-62, June 2003.

A problem with the first type of interface is that the user must first learn the commands that operate the system, and error correction may be required, Berglund et al., “Error Resolution Strategies for Interactive Television Speech Interfaces,” Human-Computer Interaction, Interact 2003, pp. 105-112, 2003. The second type of interface increases the cost and complexity of design and development. Also, it is not clear that a conversational style speech interface is suitable for interaction with a television system using a remote control, where an instant response is demanded by the user.

Another interface uses a speech-in, list-out paradigm, Divi et al., “A Speech-In List-Out Approach to Spoken User Interfaces,” Human Language Technology Conference, May 2004. That interface is based on SpokenQuery technology described by Wolf et al., “The MERL SpokenQuery Information Retrieval System: A System for Retrieving Pertinent Documents from a Spoken Query,” IEEE International Conference on Multimedia and Expo (ICME), Vol. 2, pp. 317-320, August 2002; Wolf et al., “SpokenQuery: An Alternate Approach to Choosing Items with Speech,” International Conference on Speech and Language Processing (ICSLP), ICSLP 2004, October 2004; and U.S. Pat. No. 6,877,001, “Retrieving Documents with Spoken Queries,” Wolf et al., granted Apr. 5, 2005 and incorporated herein by reference.

There, an output of a speech recognition engine is not used as a full specification of a text query, but rather as a set of tokens that can be matched with items in a database. Conceptually, this interface is similar to a textual query interface. However, a significant difference is that the recognized words in the query have a probabilistic uncertainty. That is, the speech recognizer is not perfect; similar sounding textual words are often incorrectly recognized spoken words. At best, the recognizer can only assign a confidence score.

Often, the user is faced with the problem of determining whether a requested item does not exist in a particular database or whether the spoken query was misinterpreted.

Most search engines, such as Google™, AltaVista™, and Yahoo™ use extremely sophisticated techniques to rank order a result set that is produced in response to a query. The rank order attempts to take into account the degree of relevance of the items found. The relevance can be based on the frequency and location of occurrences of the key words, the way the item is linked to other similar items, or perhaps, the amount of advertising dollars spent.

### SUMMARY OF THE INVENTION

The invention provides a method for searching a database of items using a probabilistic query as input. The query is composed of terms, for example, representations of the spoken words or phrases said by the user. Each term has an associated probability that the term was what the user intended. The data base is searched using these terms and their associated probabilities that the term matched what the user intended to produce a rank-ordered result set of items. Each item is associated with a description that includes the terms used to justify the inclusion and rank of the item, along with a probability that the term was what the user intended.

The descriptions are presented to the user as a rank-ordered result set with annotated terms and highlighting. The highlighting of the result set is in accordance with the associated probabilities. The highlighting can include the rank ordering in which the items are presented, as well as the visual appearance of the descriptions, e.g., the size, color, emphasis, or font of the letters and words. The appearance effects can be spatial, as well as temporal. For example, the words can move or blink. The highlighting can also be conveyed acoustically.

It should be noted that the highlighting is not based on search relevance scores as in prior art search engines, but rather on confidence scores of the interpretation of the query by some recognition engine.

The highlighting provides the user with feedback on how the query was interpreted and applied during the searching of the database.

### BRIEF DESCRIPTION OF THE DRAWINGS

FIG. 1 is a flow diagram of a method for presenting a result set in response to a probabilistic query according to an embodiment of the invention.

### DETAILED DESCRIPTION OF THE PREFERRED EMBODIMENT

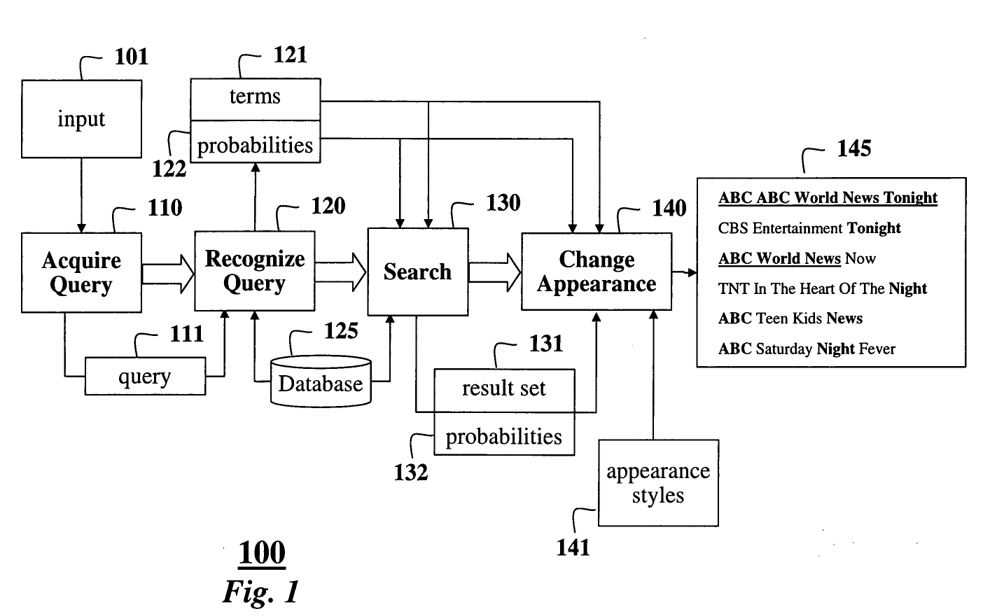

FIG. 1 shows a method 100 for presenting a result set in response to a probabilistic query according to an embodiment of the invention. Input 101 to the method 100 is a probabilistic query.

As defined herein, a probabilistic query has a degree of uncertainty associated with the interpretation of the meaning of the query. A typical probabilistic query is a spoken query. Other examples of probabilistic queries include an image or a ‘snippet’ of music.

The uncertainty in the query can be due to any combination of sources. For speech these include unclear pronunciation, environmental noises, microphone problems, etc. The recognition process itself and the speech models being matched add uncertainty. Dialectic variation in different languages increases the uncertainty about the meaning of the query.

In the case of images, there is uncertainty about the value of each pixel sampled. Lighting and shadows, and optical effects can obscure an image. Objects in images may be difficult to recognize. An image recognizer attempts to extract terms, e.g., image features such as shape, color, and size, from the image and provide a probability that each term occurs in the input image. However, complete certainty is not always possible.

It is an object of the invention to present results produced by a search engine in a way that takes into consideration these uncertainties, or a degree of confidence in the recognition process.

A query 111 is acquired 110, e.g., by a microphone or camera. The query is recognized 120 and interpreted as sets of possible terms 121. A probability 122 is assigned to each term. The recognition 120 can be performed by an automated speech recognizer, or computer vision object recognizer that has access to a database 125 that assists in the interpretation. The database can also include items to be searched 130 to generate a result set 131. The items can be web pages, images, documents, music files, and the like. Typically, the items in the result set are associated with short descriptions. The short descriptions can be generated ‘on the fly’ as the result set is produced. Typically, only the short descriptions are displayed or printed along with links to the actual items themselves, and the user can then select an item for full display.

Thus, the searching 130 of the database 125 produces the result set 131. Associated with the result set are probabilities 132 that are based on or include the probabilities 122 of recognition combined with probabilities that the terms we found were together in the database. The database results may include weights that alter the ranking order.

The result set is changed 140 to include highlighting in accordance with the probabilities 132. The term ‘highlighting’ can include visual as well as acoustic effects. The highlighted result set 145 is highlighted according to appearance styles 141 as described below.

Typically, ‘terms’ in the descriptions of the items in the result set correspond to terms in the probabilistic query. Terms with higher confidence scores or probabilities are highlighted. The terms can be partial or full words, numbers, letters, alphanumeric characters, phrases, ‘thumbnail’ images, and the like. The highlighting appearance 141 can include intensity, font, size, color, blink rate, bolding, relief, shadowing, 3D effects such ‘raised’ text, underlining, distorting, contrast, focus, fog, marking up, circling, boxing and background effects, animations, etc.

The highlighting appearance can be Boolean, e.g., bold or normal font to represent that the term occurred in the item. The highlighting can show an order, e.g., font size, or brightness relating to the confidence. The appearance can show multiple orderings at once, e.g. brightness relating to confidence and size relating to weighting of the term during the search, and color relating to something else.

The highlighting can include acoustic signals. For example, if the result set is presented via telephony, then the highlighting can consider volume, tone, frequency, rate, sound effects, inserts, overlays, such as a ringing bell.

The highlighting of images can consider distortion, color, intensity, overlays, animation, and the like. Videos can be similarly highlighted.

It should be noted that other probabilistic queries can be in the form of hand writing. For example in hand writing recognition the input can be characterized as a collection of lines that form letters and terms each with a level of confidence. The letters form words with a level of confidence that are predicted to be found in a database. The database itself contains word sequences that define the possible transcripts. In the resulting possible transcriptions of the hand writing, highlights can be used to show where database entries, matched or deviated from the hand writing terms.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. A computer-implemented method for rendering a rank-ordered result set for a probabilistic query, comprising the steps of:
acquiring a probabilistic query;
recognizing terms in the probabilistic query;
assigning a probability to each term, the probability expressing a confidence in correctly recognizing the term;
searching a database for items corresponding to the probabilistic query using the terms and the assigned probabilities to produce a result set;
highlighting the result set according to the probabilities; and
outputting the highlighted result set.

2. The method of claim 1, in which the probabilistic query is in a form of an acoustic signal.

3. The method of claim 1, in which the probabilistic query includes speech, and the terms are words.

4. The method of claim 1, in which the highlighting uses visual effects.

5. The method of claim 1, in which the highlighting uses acoustic effects.

6. The method of claim 1, in which the highlighting uses visual and acoustic effects.

7. The method of claim 4, in which the visual effects are selected from a group consisting of intensity, font, size, color, blink rate, bolding, relief, shadowing, 3D effects, underlining, distorting, contrast, focus, fog, marking up, circling, Boolean effects, boxing, background effects and animations.

8. The method of claim 4, in which the probabilistic query includes terms in a form of images, and the visual effects include distortion, color, intensity, overlays and animation.

9. The method of claim 5, in which the acoustic effects are selected from a group consisting of volume, tone, frequency, rate, sound effects, sound inserts and sound overlays.

10. The method of claim 1, in which the probabilistic query is in a form of handwriting.
